(19) United States
(12) Patent Application Publication
(10) Pub. No.: US 2017/0031184 A1
(43) Pub. Date: Feb. 2, 2017

(54) PIXEL FOR REALIZING A FULL-COLOR DISPLAY, MICRO- ELECTRO-MECHANICAL SYSTEM (MEMS) INCLUDING THE SAME AND FABRICATION METHODS THEREOF, AND METHOD TO REALIZE FULL-COLOR DISPLAY WITH SINGLE PIXEL

(71) Applicant: NATIONAL TSING HUA UNIVERSITY, Hsinchu (TW)

(72) Inventors: Cheng-Yao LO, Hsinchu (TW); Chien-Wei HUNG, Hsinchu (TW); Yi-Chu CHEN, Hsinchu (TW)

(21) Appl. No.: 15/093,775

(22) Filed: Apr. 8, 2016

(30) Foreign Application Priority Data
Jul. 31, 2015 (TW) 104124857

(51) Int. Cl. G02F 1/01

(52) U.S. Cl. CPC G02F 1/0128

(57) ABSTRACT

The present invention provides a pixel for realizing a full-color display, including an elastomer; and a plurality of microstructures disposed on the elastomer, wherein the pixel is composed of a single sub-pixel and the plurality of microstructures have the same primary morphology; wherein when applying a force to the elastomer, the plurality of microstructures have a second morphology which is different from the primary morphology. The present invention also provides a micro-electro-mechanical system (MEMS) for realizing a full-color display, fabrication methods thereof, and a method to realize a full-color display with a single pixel.

### CROSS REFERENCE TO RELATED APPLICATIONS

This application is based upon and claims the benefit of priority from the prior Taiwan Patent Application No. 104124857, filed on Jul. 31, 2015, the entire contents of which are incorporated herein by reference.

### BACKGROUND OF THE INVENTION

Field of the Invention

The present disclosure relates to a display mechanism, and in particular it relates to a pixel for realizing a full-color display, a micro-electro-mechanical system (MEMS) including the same, and fabrication methods thereof, and a method to realize a full-color display.

Description of the Related Art

Currently, depending on different materials, there are two categories of full-color display mechanisms: one category uses self-emitting materials and another uses non self-emitting materials. Non self-emitting display mechanisms can be further divided into different types, for example, the reflection type, transmission type, and other types, such as interference type, diffraction type, and switch type. The reflection-type of non self-emitting display mechanism can be realized by the nature appearance of various kinds of objects, or surface plasmons, for example. However, because most non self-emitting display mechanisms need a backlight or frontlight as the light source, their structures are more complicated. In a non self-emitting display mechanism, additional structures including optical filters are needed to present individual color and further realize the full-color display.

A full-color display is typically composed of sub-pixels such as red light (R), green light (G), and blue light (B), and a pixel includes a set of RBG sub-pixels. To attain color uniformity, a common arrangement for RBG sub-pixels includes the stripe arrangement, mosaic arrangement, and triangle arrangement, of which the simplest arrangement is the stripe arrangement. Alternatively, researchers also use gratings or shutters to conduct switching at different moment to enable a pixel to emit red light, green light, and blue light. Because the switching time is shorter than the detection limit of visual perception, the result observed by the naked eyes can be regarded as a mixture of different colored lights. Consequently, consecutive short pulses of R, G, and B resulted in a mixture of white for the naked eyes.

However, no matter what kind of arrangement of sub-pixels is used, the single pixel for realizing full color has to occupy an area or a space of at least three sub-pixels (i.e. RGB).

Surface plasmonic resonance displays have been proposed in researches. Patent application U.S. Pat. No. 8,896,907 discloses a display mechanism, including a structural layer containing metal particles. After light passes through the structural layer, the wavelength changes due to the surface plasmonic resonance theory. Patent application U.S. Pat. No. 8,749,736 discloses a mechanism of using surface plasmons to filter color. The same application reveals that surface plasmons have to be arranged in different regions on the plane to define pixel regions. Furthermore, surface plasmons in different regions are all arranged periodically but are with different sizes and densities. Patent application U.S. Pat. No. 8,045,107 discloses that plasmonic microstructures having different morphologies can present different colors.

It is known from the past researches that colors can be determined by the independent morphology of the surface plasmons, including features such as shape, density, size, and period. However, three colors of red, green, and blue require at least three different structures on the plane and occupy at least three sub-pixel areas. As demand grows for display devices with higher resolution, one challenge of the process is how to shrink the area occupied by pixels or sub-pixels in order to improve resolution without changing the original area of the display device.

U.S. Pat. No. 8,422,114 B2 discloses a tunable physical modulation for plasmonic display device, including a plasmonic layer interposed between the top and bottom electrodes and embedded in a dielectric layer. The piezoelectric material of the dielectric layer is deformed by the electric field between the top and bottom electrodes, and therefore compresses the microstructures in the plasmonic layer to modulate the plasmonic structures, which in turn modulate colors. Although this application controls features such as shape, size, density, and period of the microstructures through a piezoelectric mechanism and modulates colors by the deformation of the compressed microstructures in the plasmonic layer, the top and bottom electrodes in this application must be transparent conductors, otherwise transmissive displays cannot be achieved. However, transparent conductors such as indium tin oxide (ITO) typically have worse conductance than pure metals. Therefore, higher voltage and higher energy is required to provide enough of an electric field to produce a deformation (expansion or contraction) of the piezoelectric material of the dielectric layer. In addition, since microstructures in the plasmonic layer are embedded in the dielectric layer, the deformation is limited to contact with the material of the dielectric layer, so that only an isotropic deformation in 360° on the XY plane can be produced. That is, this application can only produce an expansion or a contraction with a limited modulation where original morphology of the microstructures remains.

Therefore, an improved display mechanism for realizing a full-color display by modulating spectrum in a smaller pixel area is desired.

### BRIEF SUMMARY OF THE INVENTION

In one embodiment, the present disclosure provides a pixel for realizing a full-color display, including an elastomer; and a plurality of microstructures disposed on the elastomer, wherein the pixel is composed of a single sub-pixel, and the plurality of microstructures have the same primary morphology; wherein when applying a force to the elastomer, the microstructures have a second morphology which is different from the primary morphology.

In another embodiment, the present disclosure also provides a micro-electro-mechanical system (MEMS) for realizing a full-color display, including at least one of the pixels for realizing a full-color display as set forth above.

In still another embodiment, the present disclosure further provides a fabrication method for the MEMS for realizing a full-color display, including providing a substrate; applying a first front etching and a first back etching to the substrate; filling an elastomer into an opening formed by the first front etching; forming a plurality of microstructures on the elastomer to compose a pixel, wherein the pixel is composed of a single sub-pixel; applying a second front etching and a second back etching to the substrate; and etching the substrate recessed on the elastomer by a third back etching to expose the elastomer to form a MEMS with a suspended movable member.

In still another embodiment, the present disclosure further provides a method to realize a full-color display with a single pixel, including providing a MEMS for realizing a full-color display as set forth above, wherein the plurality of microstructures of each pixel have a primary morphology responsive to a first spectrum; applying a force to the elastomer of the MEMS, so that the plurality of microstructures disposed on the elastomer produce a second morphology responsive to a second spectrum, wherein the second spectrum is different from the first spectrum; and releasing the force applied to the elastomer, so that the plurality of microstructures disposed on the elastomer revert to the primary morphology.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 illustrates a cross-sectional view of a pixel for realizing a full-color display according to an embodiment of the present disclosure;

FIG. 2 illustrates a plan view of a pixel for realizing a full-color display according to an embodiment of the present disclosure;

FIG. 3 illustrates a plan view of a pixel for realizing a full-color display after a force (F) along the X-direction is applied to the pixel according to an embodiment of the present disclosure;

FIGS. 4A-4F illustrate intermediate steps of fabricating a micro-electro-mechanical system (MEMS) for realizing a full-color display according to an embodiment of the present disclosure;

FIG. 5 illustrates the structural differences of microstructures on the pixel for realizing a full-color display before and after the actuation of MEMS; and

FIG. 6 illustrates the experimental results of using a mechanical force to modulate the morphology of the microstructure disposed on the elastomer.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present disclosure describes specific embodiments relating to a full-color display mechanism. The embodiments of the present disclosure may be applied to various display devices, for example, a reflection-type or transmission-type of non self-emitting full-color display.

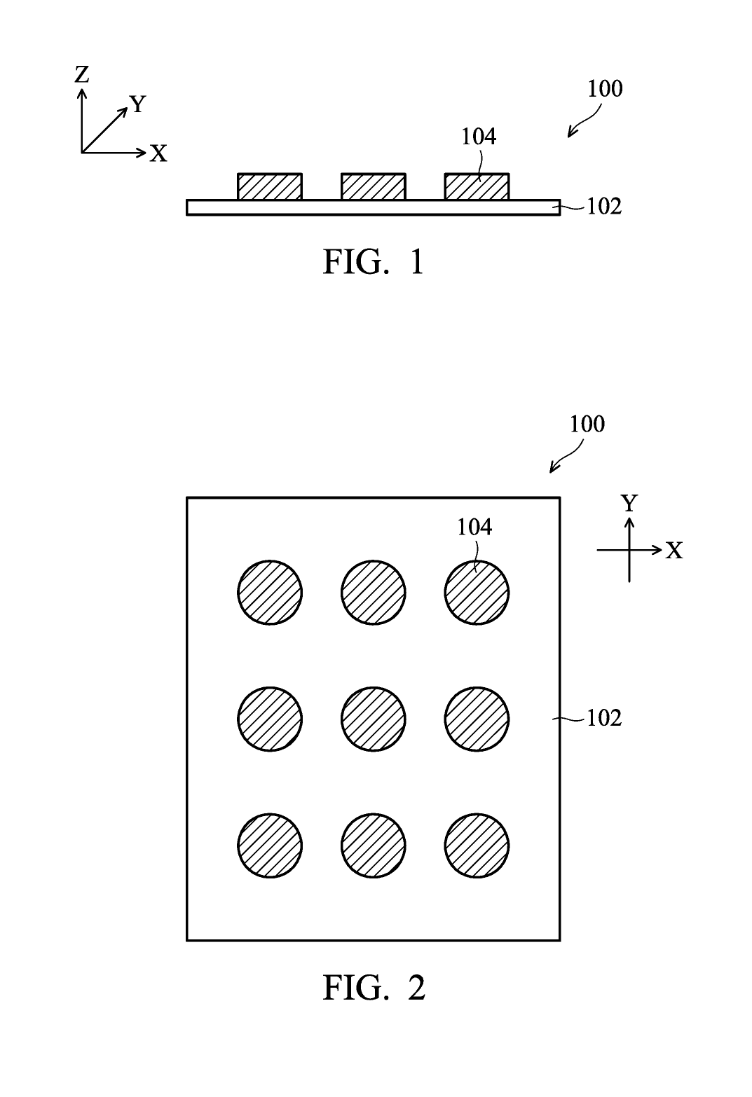

FIG. 1 illustrates a cross-sectional view of a pixel 100 for realizing a full-color display according to an embodiment of the present disclosure. FIG. 2 illustrates a plan view of a pixel 100 for realizing a full-color display according to an embodiment of the present disclosure. The pixel 100 includes an elastomer 102 and a plurality of microstructures 104 disposed on the elastomer 102. The elastomer 102 may be selected from a group consisting of at least one elastic organic polymer, such as polydimethyl siloxane (PDMS), rubber, parylene, etc. The elastomer 102 may have a thickness in a range of, for example, 1-1000 μm. It should be realized that when the elastomer 102 is formed of a transparent organic polymer, the pixel 100 for realizing a full-color display provided in the present disclosure may be used in a transmission-type display structure, and when the elastomer 102 is formed of an opaque organic polymer, the pixel 100 for realizing a full-color display provided in the present disclosure may be used in a reflection-type display structure. In other words, any organic polymer, not limited to the above material, may be used to form the elastomer 102.

The “morphology” described in the present specification represents all of the possible appearance features, including shape, size, density, period, etc. In the pixel 100 for realizing a full-color display provided in the present disclosure, the plurality of microstructures may have a single primary morphology. For example, before applying a force, these microstructures may have the same shape, the same size, and a predetermined density and period. It should be noted that each of the pixels 100 is composed of a single sub-pixel. That is, the pixel 100 described herein only occupies an area or a space that a single sub-pixel occupies on the plane. Such a structural design not only simplifies the complexity of the process, but also effectively reduces the space occupied by the pixel, so that the resolution of the display is further improved by using this pixel. Each of the microstructures conforms to the surface plasmonic resonance (SPR) theory. The microstructures may be composed of a metal with ductility, including aluminum, gold, silver, copper, platinum, or an alloy including a combination thereof. The microstructures may also be composed of multilayer of metals with ductility.

In one embodiment, when applying a force to the elastomer 102, the microstructures 104 produce a second morphology which is different from the primary morphology. The second morphology changes with different directions and strengths of the applied force. As mentioned above, the described “morphology” in the present specification represents all of the possible appearance features, including shape, size, density, period, etc. However, the change of morphology described herein does not limit to the condition that the shape, size, density, and period are simultaneously changed, but it also includes the condition that only one, two, or three of these conditions is/are changed. For example, in one embodiment, the second morphology of the microstructures may have the same shape as the primary morphology, but have a different size, density, and period from the primary morphology. In another embodiment, the second morphology of the microstructures may have the same period as the primary morphology, but have a different shape, size, and density from the primary morphology. The above conditions are merely examples, and the morphology change of the microstructures is not limited thereto.

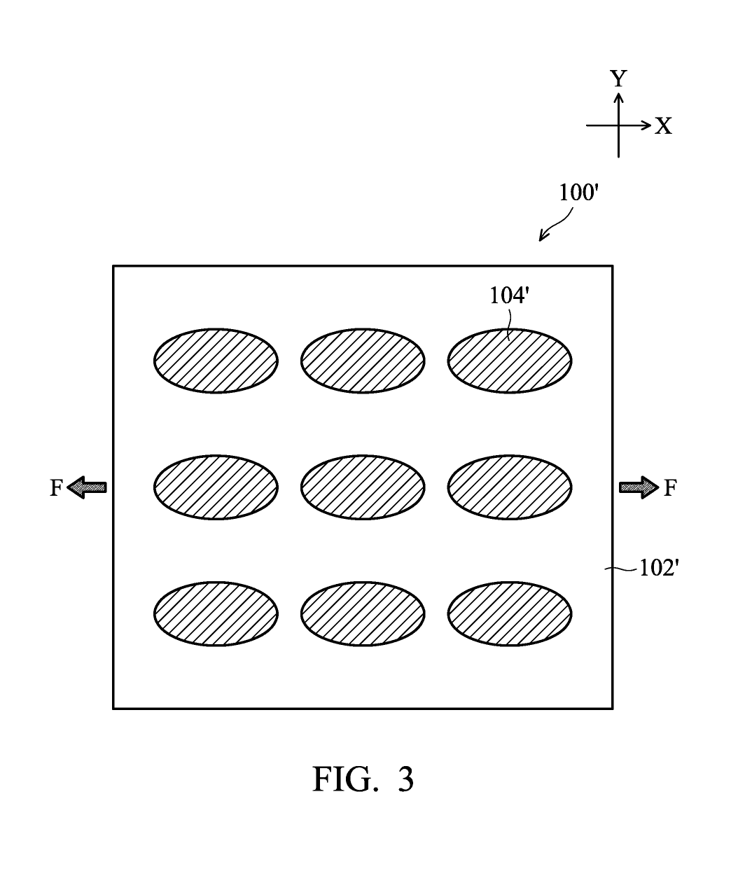

FIG. 3 illustrates a plan view of a pixel 100′ for realizing a full-color display after a force along the X-direction is applied to the pixel according to an embodiment of the present disclosure. As shown in FIG. 3, in one embodiment, when the shape of the primary morphology of the microstructures is a spherical shape and the applied force F is a one-dimensional force along the X-direction, with the deformation of the elastomer 102′, the shape of the second morphology of the microstructures 104′ may be an oval stretched along the X-direction. Although the drawing of the present disclosure merely illustrates an embodiment of applying a force along the X-direction, but the applied force of the present disclosure is not limited thereto. It should be realized that other forces may be applied. For example, in one embodiment, when the shape of the primary morphology of the microstructures is a spherical shape and the applied force F is a two-dimensional force along the X-direction and Y-direction simultaneously, the shape of the second morphology produced by the microstructures may be a 360° enlarged spherical shape on the XY plan. For example, in another embodiment, when the shape of the primary morphology of the microstructures is a spherical shape and the applied force F is a multi-dimensional force along different directions, the shape of the second morphology produced by the microstructures may be a non-spherical shape, such as a triangle, a rectangle, or any irregular shapes. Moreover, since the space between each of the microstructures 104′ differs from that between original microstructures 104 after applying the force F, the density and period of the primary morphology of the microstructures 104 changes.

In accordance with another embodiment of the present disclosure, a MEMS is provided for realizing a full-color display, including at least one of the pixels for realizing a full-color display as set forth above. The resulting MEMS may deform the elastomer 102 by using any appropriate driving techniques, such as an electrostatic force, a piezoelectric force, a fluidic force, a thermal force, or the like. In one embodiment, MEMS may support the two-dimensional or three-dimensional actuation to realize the modulation of the morphology, including features such as shape, size, density, and period, of the pixel structure.

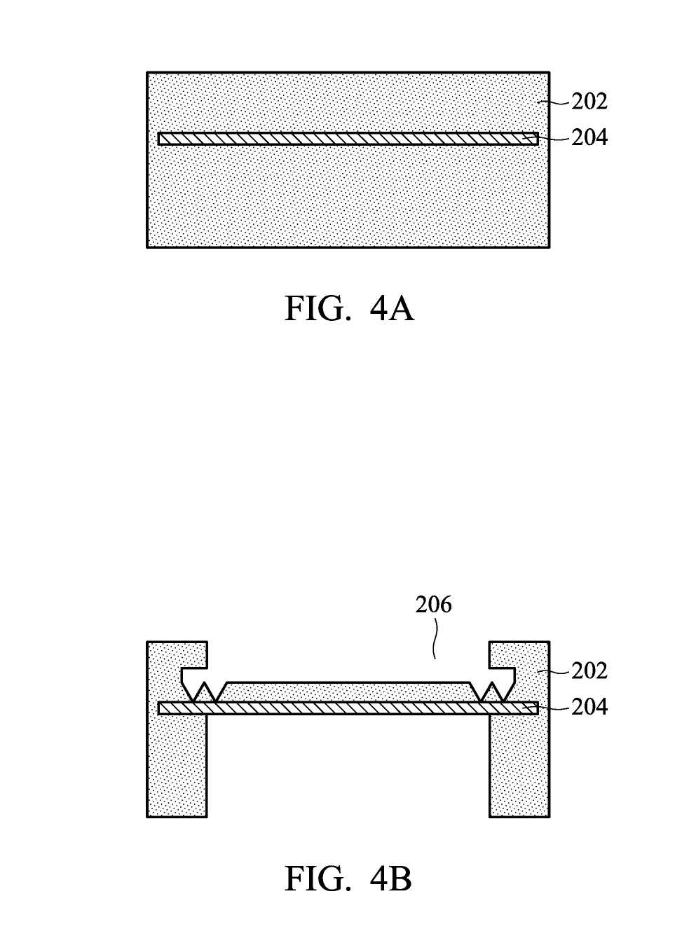

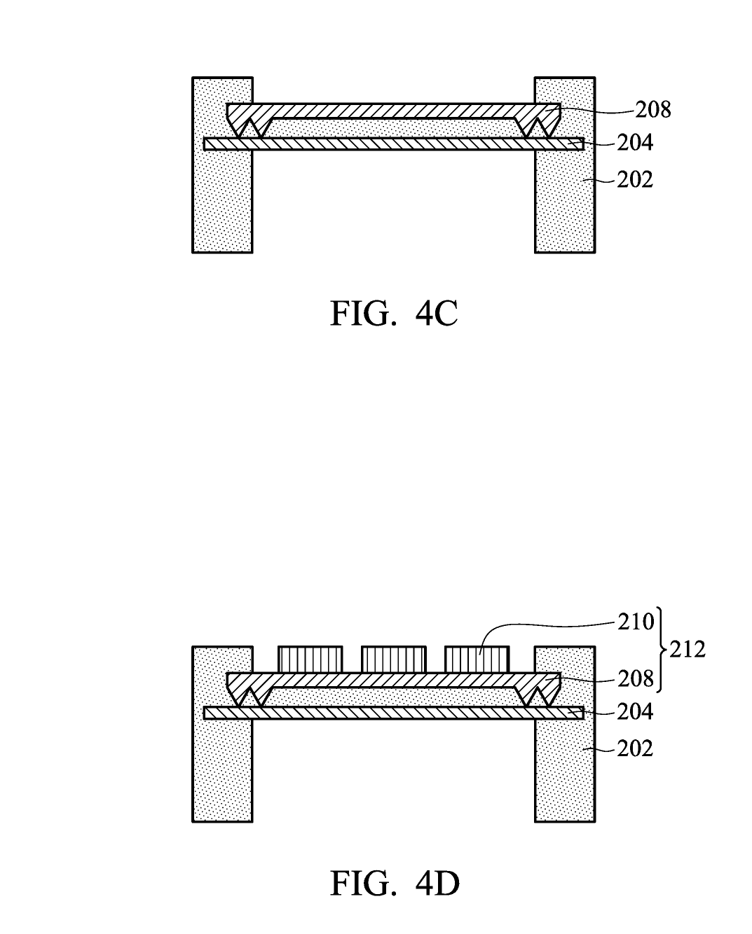

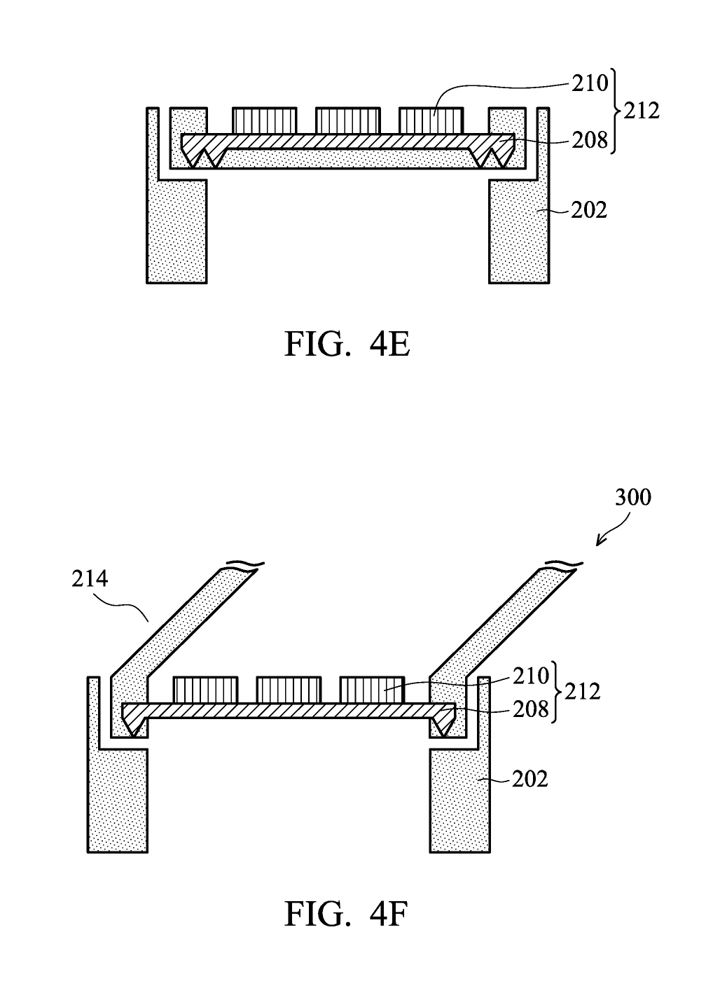

FIGS. 4A-4F illustrate intermediate steps of fabricating the MEMS for realizing a full-color display according to an embodiment of the present disclosure. For the purpose of explanation, the following embodiments include some specific materials or arrangements of components, but the present disclosure is not limited thereto. First, as shown in FIG. 4A, a silicon substrate 202 is provided containing a silicon oxide 204, or alternatively, the substrate may be formed of other semiconductor materials, including silicon germanium, silicon carbide, gallium nitride, glass, aluminum oxide, a combination thereof, or the like. In addition, other substrates including a multi-layered substrate, a gradient substrate, a hybrid orientation substrate, or any combination thereof may also be used.

Next, referring to FIG. 4B, a first front etching and a first back etching is applied to the silicon substrate 202. An opening 206 is formed in the silicon substrate 202 through the first front etching, and the opening 206 has an inward depressed space. Thereafter, an elastomer 208 filled into the opening 206 formed by the first front etching, as shown in FIG. 4C. As mentioned above, the elastomer 208 may be selected from a group consisting of at least one elastic organic polymer such as polydimethyl siloxane (PDMS), rubber, parylene, etc.

Next, a plurality of microstructures 210 is formed on the elastomer 208. The periodically distributed microstructures 210 are arranged in an array and form a single pixel 212 together with the elastomer 208, as shown in FIG. 4D. The step of forming the plurality of microstructures may be achieved by a deposition process and a subsequent lithography process. The deposition process may include chemical vapor deposition (CVD), physical vapor deposition (PVD), or the like. The lithography process may include lithography processes used in a traditional semiconductor process. In such cases, the features of the microstructures 210 of the pixel 212 are similar to those described before, and hence are not discussed again to avoid unnecessary repetition. FIG. 4E illustrates the further application of a second front etching and a second back etching to the substrate 202 after forming the plurality of microstructures 210.

Finally, in FIG. 4F, a MEMS 300, including a pixel 212, is formed. The MEMS 300 includes a suspended movable member 214. The suspended movable member 214 is formed by etching the substrate 202 recessed on the elastomer 208 through a third back etching to exposure the elastomer 208. Therefore, the suspended movable member 214 may be used in a transmission-type or a reflection-type display component to modulate colors.

The first front etching, second front etching, first back etching, second back etching, and third back etching may independently include a dry etching, a wet etching, an isotropic etching process, an anisotropic etching process, a reactive ion etch (RIE), or a combination thereof. For example, the first front etching may be an anisotropic dry etching process plus an isotropic wet etching process which make the opening 206 have an inward recessing space and make the silicon substrate 202 have a non-planar structure, so that the two ends of the subsequently filled elastomer 208 may be located in the silicon substrate 202. Thus, the silicon substrate 202 and the elastomer 208 are tightly bonded in the MEMS 300 and the force initiated by the MEMS 300 may be transmitted to the elastomer 208 through the silicon substrate 202.

The present disclosure provides a method to realize a full-color display with a single pixel, including providing a MEMS for realizing a full-color display as set forth above, wherein the plurality of microstructures of each pixel have a primary morphology responsive to a first spectrum. The first spectrum may be a spectrum of any appropriate light source.

A force is applied to the elastomer of the MEMS so that the plurality of microstructures disposed on the elastomer have a second morphology responsive to a second spectrum. By applying a force, the morphology of the microstructures in the pixel changes. For example, the second wave band to which the second morphology responds may be a red light (R), green light (G), blue light (B), or spectra of other colors of visible light. Lastly, the force applied to the elastomer is released, so that the microstructures disposed on the elastomer revert to the primary morphology.

It should be noted that the change of morphology described herein does not limit to the condition that the shape, size, density, and period are simultaneously changed, but it also includes the condition that only one, two, or three of these conditions is/are changed. For example, in one embodiment, the second morphology of the microstructures may have the same shape as the primary morphology, but have a different size, density, and period from the primary morphology. In another embodiment, the second morphology of the microstructures may have the same period as the primary morphology, but have a different shape, size, and density from the primary morphology. The above conditions are merely examples, and the morphology change of the microstructures is not limited thereto.

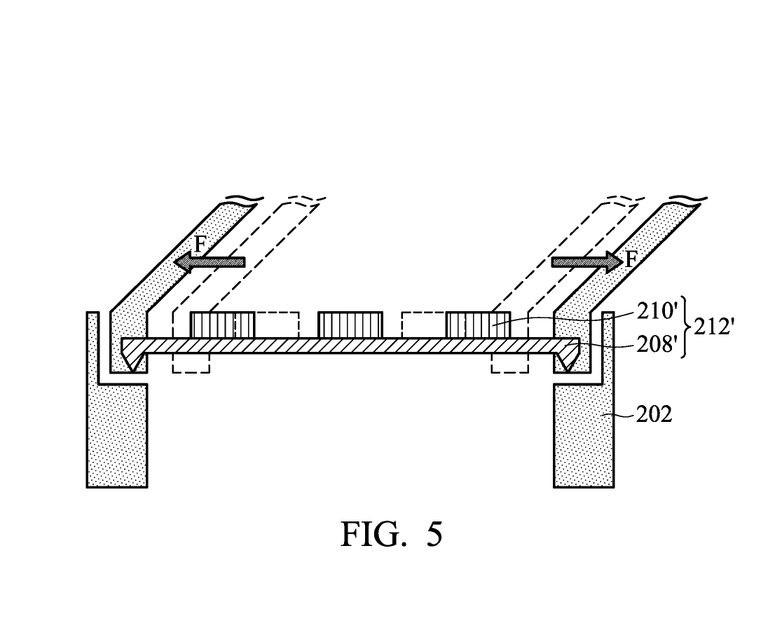

FIG. 5 illustrates the structural differences of the microstructures 210 on the pixel 212 for realizing a full-color display and the structural differences of microstructures 210′ on the pixel 212′ for realizing a full-color display before and after the actuation of MEMS. It should be noted that the morphology change shown in FIG. 5 is merely one of the change statuses. The morphology of the microstructures on the pixels may have different change statuses according to the strengths and directions of the applied force and is not limited thereto.

The full-color display mechanism of the present disclosure may be driven by an MEMS, and a mechanical force may be provided by the actuation of the MEMS. The applying of a force to the elastomer may be achieved by optionally using a fluidic force, a thermal force, or a combination thereof. For example, a fluidic force may optionally be used. For example, using a liquid or a gas to apply a force to the elastomer in the pixel (or MEMS) for realizing a full-color display, or alternatively, using a thermal force, such as heating, to deform the elastomer in the pixel for realizing a full-color display, to further deform the morphology of the microstructures in the pixel. All of the above are able to achieve the purpose of producing different colors such as RGB to display full color. In cases where the step of applying a force to the elastomer in the pixel (or MEMS) for realizing a full-color display is achieved by using a thermal force, the elastomer may include at least two organic polymers with different thermal expansion rates.

In the pixel (or MEMS) for realizing a full-color display provided in the present disclosure, the used pixel only occupies an (onefold) area that a single sub-pixel occupies. The microstructures in the pixel are deformed by using a force to change its morphology, including features such as shape, size, density, period, etc. Due to the surface plasmonic resonance (SPR) theory, these different features respond to different spectra, and therefore present different colors at the same time. In other words, the present disclosure uses forces such as a mechanical force, a fluidic force, a thermal force and so on to support the switching of different morphologies of the microstructures in the pixel to different spectra, and this therefore achieves the purpose of realizing a full-color display by a single pixel; more specifically, a pixel that contains only one single sub-pixel.

In the following, the inventors of the present disclosure provide examples to illustrate the results of using a mechanical force to modulate the microstructures in the pixel on the elastomer.

### Example 1

Polydimethyl siloxane (PDMS) having a thickness of 250 μm was used as the material for the elastomer. On the elastomer, silver (Ag) was used in the microstructures of a cylinder for surface plasmonic resonance. The primary height of the microstructure of the cylinder was 20 nm, and the primary diameter of the microstructure of the cylinder was 200 nm. A mechanical strain of 0-100% was applied to the elastomer by a circular carrier. The degree of deformation of the elastomer and the microstructure thereon was observed from the top view (circle) and recorded.

### Example 2

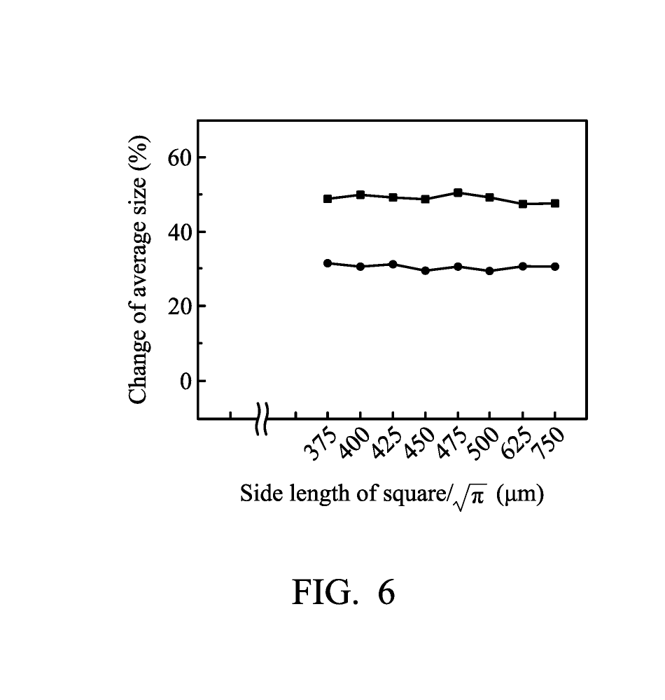

Polydimethyl siloxane (PDMS) having a thickness of 250 μm was used as the material for the elastomer. On the elastomer, silver (Ag) was used in the microstructures of a rectangular column for surface plasmon resonance. A mechanical strain of 0-100% was applied to the elastomer by a circular carrier. The degree of deformation of the elastomer and the microstructure thereon was observed from the top view (rectangular) and recorded. The results were shown in FIG. 6.

Since the microstructures of surface plasmonic resonance were fabricated on the elastomer, the microstructure deformed with the deformation of the elastomer after receiving the force. So far, it is known that a significant color switch could be produced when 10% deformation was reached. However, as shown in FIG. 6, the degree of deformation of the microstructures in the examples was represented by “Change of average size (%)”. The rectangular line illustrates that approximately 50% strain was produced when 40% force was applied, while the circle line illustrates that approximately 30% strain was produced when 20% force was applied.

In other words, the elastomer and the microstructures of surface plasmonic resonance may produce a deformation as high as 50%. Such a degree of deformation may satisfy the applications of modulation for every color in the visible light spectrum.

To sum up the above: the pixel (or MEMS) for realizing a full-color display provided in the present disclosure uses a single sub-pixel area and forces such as a mechanical force, a fluidic force, a thermal force, and so on to produce deformation of the microstructures in the pixel, change the morphology thereof, including features such as shape, size, density, period, etc., and realize the appearance of different colors at the same time. In addition, the pixel (or MEMS) for realizing a full-color display provided in the present disclosure may produce a deformation as high as 50% by receiving a force, wherein the degree of deformation satisfies the applications of modulation for every color in the visible light spectrum. The purpose of realizing full color was achieved by using a single sub-pixel.

While the disclosure has been described by way of example and in terms of the embodiments, it is to be understood that the disclosure is not limited to the disclosed embodiments. It will be apparent to those skilled in the art that various modifications and variations can be made to the disclosed embodiments. Therefore, the true scope of the disclosure is indicated by the following claims and their equivalents.

What is claimed is:

1. A pixel for realizing a full-color display, comprising:
an elastomer; and
a plurality of microstructures disposed on the elastomer;
wherein the pixel is composed of a single sub-pixel and the plurality of microstructures have the same primary morphology,
wherein when applying a force to the elastomer, the plurality of microstructures have a second morphology which is different from the primary morphology.

2. The pixel for realizing a full-color display as claimed in claim 1, wherein the elastomer is selected from a group consisting of at least one elastic organic polymer, comprising: polydimethyl siloxane (PDMS), rubber, parylene, or a combination thereof, and the elastomer has a thickness in a range of 1-1000 μm.

3. The pixel for realizing a full-color display as claimed in claim 1, wherein the plurality of microstructures are composed of a metal or a multilayer of metals with ductility, wherein the metal comprises: aluminum, gold, silver, copper, platinum, or an alloy comprising a combination thereof.

4. The pixel for realizing a full-color display as claimed in claim 1, wherein the plurality of microstructures are arranged in an order selected from a group consisting of a symmetrical array and an asymmetric array.

5. The pixel for realizing a full-color display as claimed in claim 1, wherein the primary morphology of the plurality of microstructures has a size in a range of 100-900 nm.

6. A micro-electro-mechanical system (MEMS) for realizing a full-color display, comprising:
at least one of the pixels for realizing a full-color display as claimed in claim 1.

7. A fabrication method for a micro-electro-mechanical system (MEMS) for realizing a full-color display, comprising:
providing a substrate;
applying a first front etching and a first back etching to the substrate;
filling an elastomer into an opening formed by the first front etching;
forming a plurality of microstructures on the elastomer to compose a pixel, wherein the pixel is composed of a single sub-pixel;
applying a second front etching and a second back etching to the substrate; and
etching the substrate recessed on the elastomer by a third back etching to expose the elastomer to form a MEMS with a suspended movable member.

8. The fabrication method for the MEMS for realizing a full-color display as claimed in claim 7, wherein the substrate comprises silicon, silicon oxide, silicon germanium, silicon carbide, gallium nitride, glass, aluminum oxide, or a combination thereof.

9. The fabrication method for the MEMS for realizing a full-color display as claimed in claim 7, wherein each of the first front etching, the second front etching, the first back etching, the second back etching, and the third back etching independently comprises a dry etching, a wet etching, an isotropic etching, an anisotropic etching, a reactive ion etching (RIE), or a combination thereof.

10. The fabrication method for the MEMS for realizing a full-color display as claimed in claim 7, wherein the elastomer is selected from a group consisting of at least one elastic organic polymer comprising: polydimethyl siloxane (PDMS), rubber, parylene, or a combination thereof, and the elastomer has a thickness in a range of 1-1000 μm.

11. The fabrication method for the MEMS for realizing a full-color display as claimed in claim 7, wherein the plurality of microstructures are composed of a metal or a multilayer of metals with ductility, wherein the metal comprises: aluminum, gold, silver, copper, platinum, or an alloy comprising a combination thereof.

12. The fabrication method for the MEMS for realizing a full-color display as claimed in claim 7, wherein the plurality of microstructures are arranged in an order selected from a group consisting of a symmetrical array and an asymmetric array.

13. The fabrication method for the MEMS for realizing a full-color display as claimed in claim 7, wherein the primary morphology of the plurality of microstructures has a size in a range of 100-900 nm.

14. A method to realize a full-color display with single pixel, comprising:
providing a micro-electro-mechanical system (MEMS) for realizing a full-color display as claimed in claim 6, wherein the plurality of microstructures of each pixel have a primary morphology responsive to a first spectrum;
applying a force to the elastomer of the MEMS, so that the plurality of microstructures disposed on the elastomer produce a second morphology responsive to a second spectrum, wherein the second spectrum is different from the first spectrum; and
releasing the force applied to the elastomer, so that the plurality of microstructures disposed on the elastomer revert to the primary morphology.

15. The method to realize a full-color display with single pixel as claimed in claim 14, wherein the step of applying a force to the elastomer of the MEMS is achieved by applying a mechanical force, a fluidic force, a thermal force, or a force comprising a combination thereof.

16. The method to realize a full-color display with single pixel as claimed in claim 14, wherein when the step of applying a force to the elastomer of the MEMS is achieved by the mechanical force, the force is a one-dimensional force, a two-dimensional force, a three-dimensional force, or a multi-dimensional force.

17. The method to realize a full-color display with single pixel as claimed in claim 14, wherein the second spectrum is in a range of a visible range.
